(19) United States
(12) Patent Application Publication
(10) Pub. No.: US 2008/0201955 A1
(43) Pub. Date: Aug. 28, 2008

(54) Electric hair clipper with automatic speed control

(76) Inventor: Anthony Kit Lun Leung, North Point (CN)

Correspondence Address: Lawrence Cruz;Conair Corporation, One Cummings Point Road, STAMFORD, CT, 06902, US

(21) Appl. No.: 11/716,163

(22) Filed: Mar. 9, 2007

Related U.S. Application Data
(60) Provisional application No. 60/781,180, filed on Mar. 10, 2006.

(51) Int. Cl. B26B 19/00

(52) U.S. Cl. 30/43.1; 30/196; 30/43

(57) ABSTRACT

A control system (10) in a hair clipper that senses increased load while operating and, as a result, automatically and momentarily increases blade speed output for more efficient cutting.

### CROSS-REFERENCE TO RELATED APPLICATIONS

None.

### TECHNICAL FIELD

The present invention relates to electric hair clippers for shaving and cutting hair and, more particularly, to hair clippers having components and circuitry designed to sense a load increase while operating and, in response to such load increase, to increase operating speed of the blades to more efficiently cut or shave hair causing the load increase.

### BACKGROUND OF THE INVENTION

Known clippers for shaving, cutting and trimming hair typically operate at a constant speed. This is true whether or not the clipper is a one-speed unit or has multiple speed settings. When increased resistance is encountered, for example, when the blades pass from relatively thin hairs to hairs that are thicker or more difficult to cut, the corresponding increased load causes the motor to slow down and lose momentum.

Known electric motorized devices include motor speed feedback systems that can sense load or output speed and, resultantly, increase power to the motor to return the device to its normal operating speed. No known device automatically and momentarily changes the operating speed to an increased speed that is above normal operating speed.

### OBJECTS OF THE INVENTION

It is an object of the present invention to provide an improved hair clipper having a system that detects a load increase and that automatically and momentarily increases blade speed in response in order to more efficiently cut a more resistant section of hair.

These objects, as well as others, are achieved by the present invention.

### BRIEF SUMMARY OF THE INVENTION

The present invention achieves the above-mentioned objects by utilizing a control system in a hair clipper that senses increased load while operating and, as a result, automatically and momentarily increases blade speed output for more efficient cutting.

### BRIEF DESCRIPTION OF THE DRAWINGS

FIG. 1 is a schematic diagram of certain internal components of a clipper according to the present invention.

FIG. 2 is a circuit diagram of a control circuit according to the present invention.

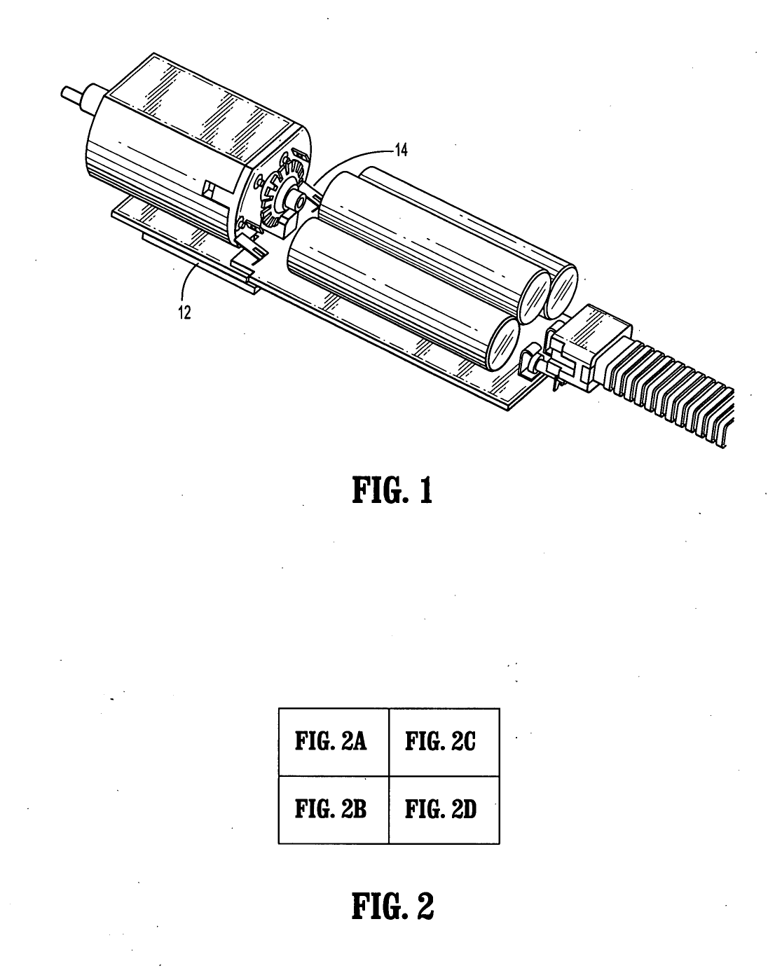

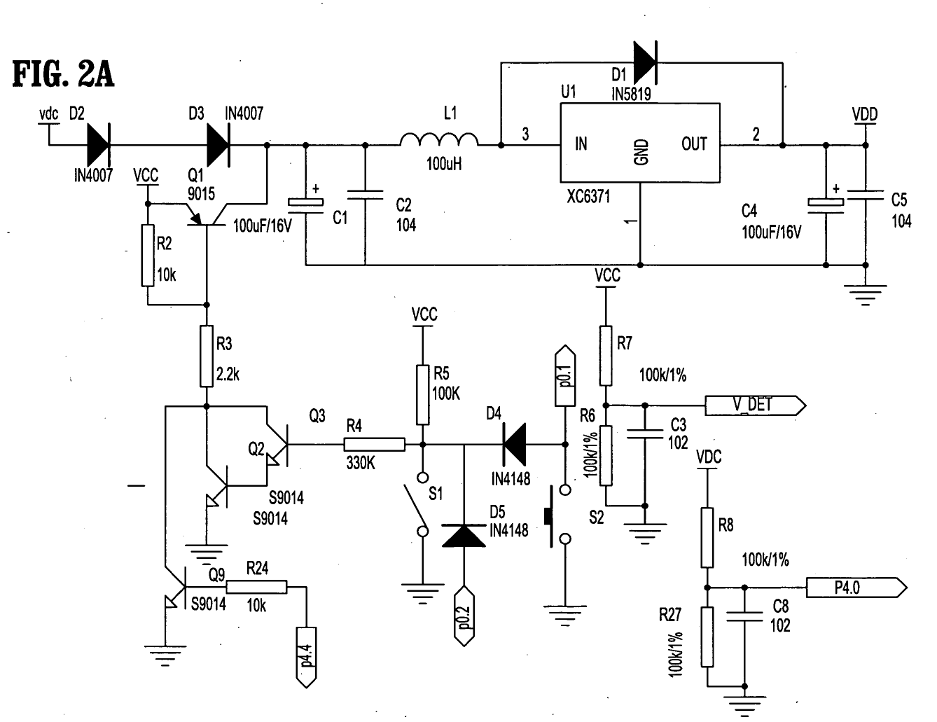

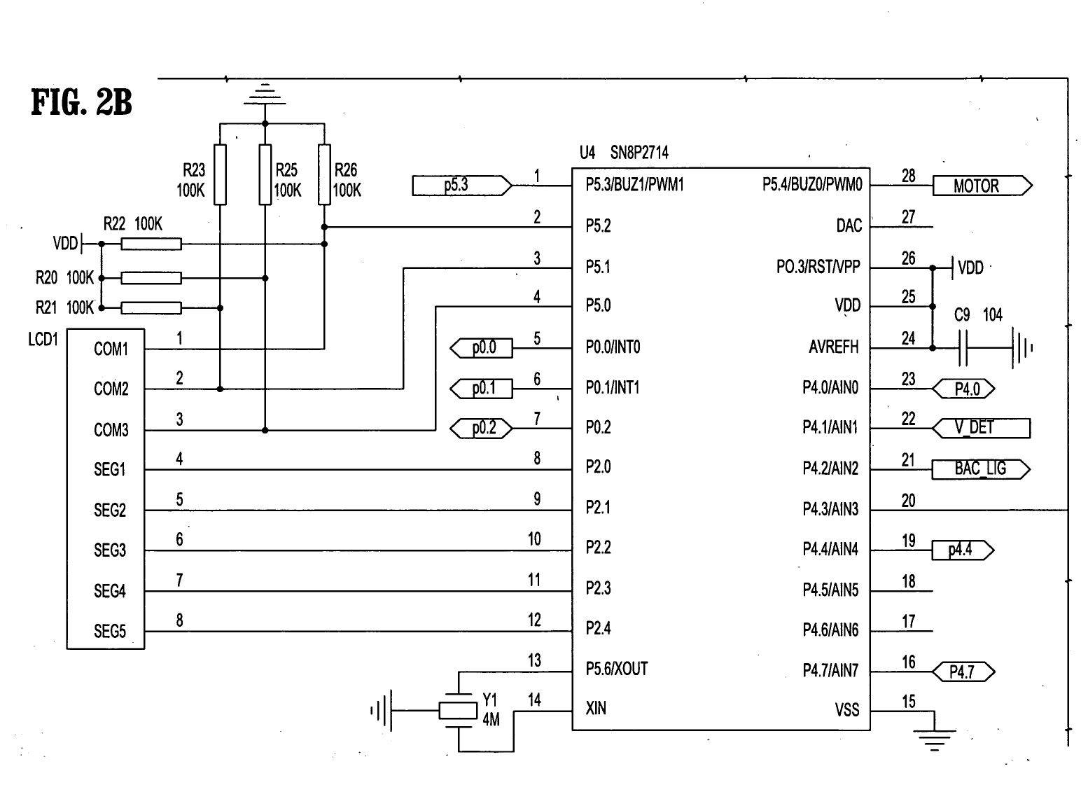

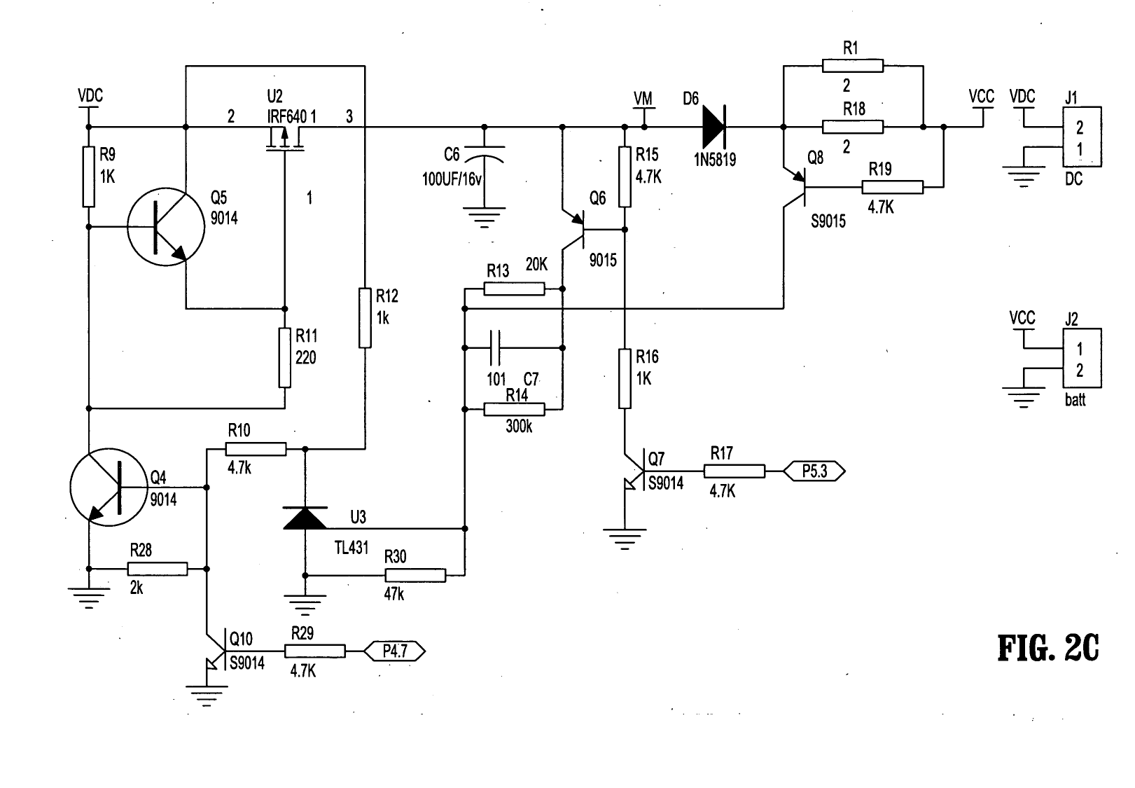

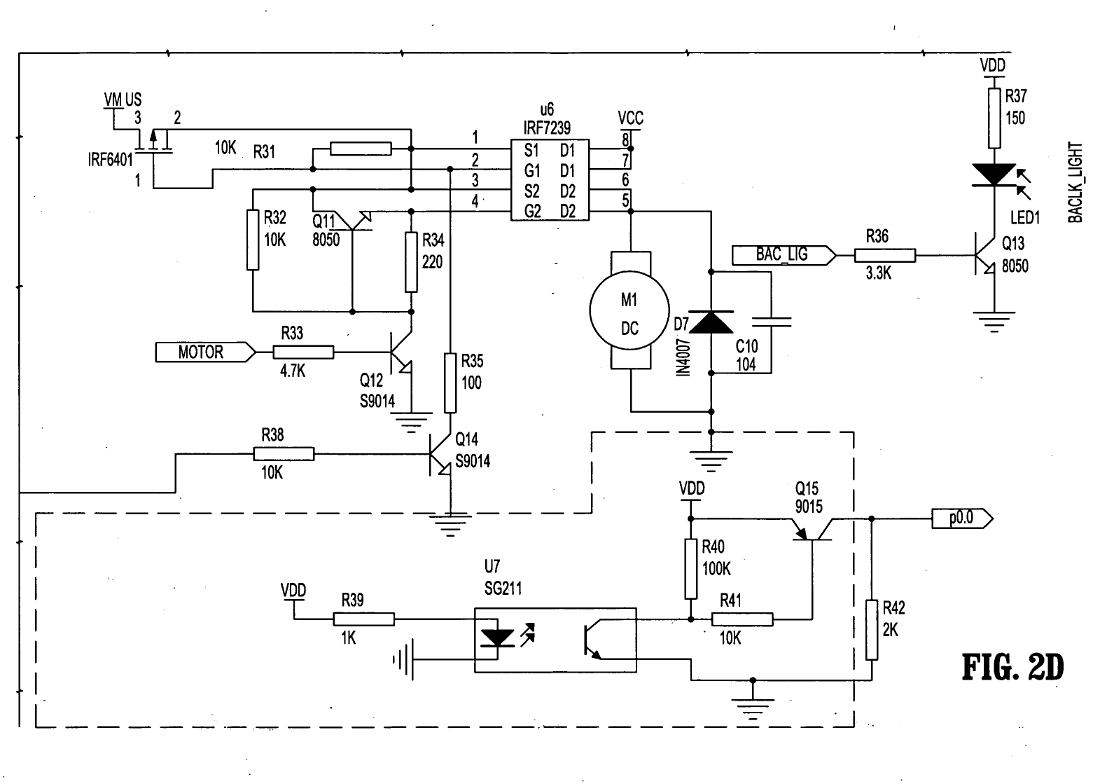

### DESCRIPTION OF THE PREFERRED EMBODIMENT

A conventional hair clipper (not shown) for cutting, shaving or trimming hair having conventional components is equipped with a control circuit (10) in order to achieve operation as set forth herein.

While the clipper is operating at a predetermined, constant motor speed and, thus, the blades are also moving at a relatively constant speed, a user moves the blades across an area of hair to be cut. A photoelectric cell (12) is arranged as is known to those skilled in the art to measure the motor's rotational speed and transmit corresponding data to a microprocessor (not shown). A photoelectric switch associated with the cell (12) reads signals from a component mounted on the motor axis (14).

If, while operating at a normal speed, the user moves to a more cut-resistant section of hair, motor speed will decrease. This change in speed is detected by the cell (12) and microprocessor. The microprocessor then accordingly adjusts the pulse width modulation of the motor to increase motor speed and, thus, blade speed. The increase is in an amount to result in an operating speed that is greater than normal operating speed in order to more efficiently cut the specific section of hair. When the resistance load decreases, the cell (12) and microprocessor detect the resultant greater motor speed and, in response, adjust speed back to normal operating speed.

While the preferred embodiments of the present invention have been herein described, various modification may be made without departing from the scope of the present invention.

What is claimed is:

1. An appliance of the type comprising an electric motor and a set of motor driven cutting elements for cutting hair, said appliance comprising
a control system for causing said motor to drive said cutting elements at a first constant speed;
a speed detection system for detecting said first constant speed and for detecting a change in speed, wherein when the speed of said cutting elements decreases below said first constant speed, said control system causes said motor to drive said cutting elements at a second constant speed which is greater than said first constant speed.

2. An appliance according to claim 1, wherein
said control system is adapted to cause said motor speed to decrease back to said first constant speed if said speed detection system detects an increase in said second constant speed.

3. An appliance according to claim 1, wherein
said speed detection system comprises a photoelectric cell and a photoelectric switch.
